(19) United States
(12) Patent Application Publication
(10) Pub. No.: US 2026/0304262 A1
(43) Pub. Date: Oct. 1, 2026

(54) TIME ALIGNMENT FOR INTER-CELL MOBILITY

(71) Applicant: Telefonaktiebolaget LM Ericsson (PUBL), Stockholm (SE)

(72) Inventors: Claes TIDESTAV, BÅLSTA (SE); Icaro Leonardo DA SILVA, SOLNA (SE); Antonino ORSINO, KIRKKONUMMI (FI); Pontus WALLENTIN, LINKÖPING (SE)

(21) Appl. No.: 19/475,773

(22) PCT Filed: Apr. 17, 2024
(86) PCT No.: PCT/SE2024/050372

§ 371 Date: Oct. 16, 2025

Related U.S. Application Data
(60) Provisional application No. 63/496,437, filed on Apr. 17, 2023.

(51) Int. Cl. H04W 36/08; H04W 56/00

(52) U.S. Cl. CPC H04W 36/08; H04W 56/0045

(57) ABSTRACT

According to some embodiments, a method is performed by a wireless device for layer one, L1, layer two, L2, mobility, LTM, cell switch. The method comprises receiving (1212) an indication of a timing alignment setting to use in a candidate cell; and performing (1214) an LTM cell switch to the candidate cell as a target cell, wherein the wireless device uses the indicated timing alignment setting when communicating with the target cell.

### TECHNICAL FIELD

Embodiments of the present disclosure are directed to wireless communications and, more particularly to time alignment for inter-cell mobility.

### BACKGROUND

Third Generation Partnership Project (3GPP) Release 18 includes a work item for further New Radio (NR) mobility enhancements. The work item includes layer 1 (L1)/layer 2 (L2) based inter-cell mobility. According to the work item description (WID) (RP-223520, 3GPP work item description: Further NR mobility enhancements, MediaTek Inc, Apple, 3GPP TSG RAN Meeting #98-e, Electronic Meeting, Dec. 12-16, 2022), when a user equipment (UE) moves from the coverage area of one cell to another cell, a serving cell change is performed. Currently, serving cell change is triggered by layer 3 (L3) measurements and is done by Radio Resource Control (RRC) signaling triggered Reconfiguration with Synchronization for change of PCell and PSCell, as well as release add for SCells when applicable. All cases involve complete L2 (and L1) resets, leading to longer latency, larger overhead and longer interruption time than beam switch mobility. The goal of L1/L2 based inter-cell mobility is to enable a serving cell change via L1/L2 signaling to reduce the latency, overhead, and interruption time.

The work item includes the following objectives. One objective is to specify mechanism and procedures of L1/L2 based inter-cell mobility for mobility latency reduction. This includes configuration and maintenance for multiple candidate cells to facilitate fast application of configurations for candidate cells; dynamic switch mechanism among candidate serving cells (including SpCell and SCell) for the potential applicable scenarios based on L1/L2 signaling; L1 enhancements for inter-cell beam management, including L1 measurement and reporting, and beam indication; timing advance management; and central unit (CU)-distributed unit (DU) interface signaling to support L1/L2 mobility.

The procedures of L1/L2 based inter-cell mobility are applicable to the following scenarios: standalone, carrier aggregation (CA) and NR dual connectivity (NR-DC) case with serving cell change within one cell group (CG); intra-DU case and intra-CU inter-DU case (applicable for standalone and CA; both intra-frequency and inter-frequency; both frequency range one (FR1) and frequency range two (FR2); and source and target cells may be synchronized or non-synchronized.

3GPP is discussing solutions for L1/L2 based inter-cell mobility (also referred to as LTM, L1/L2-triggered mobility, or lower layer-triggered mobility). A basic principle with L1/L2-triggered mobility (LTM) is that the UE is preconfigured, by the network, with an RRC configuration per LTM candidate cell, sometimes also referred to as a LTM candidate cell configuration. The LTM candidate cell configuration may be an RRCReconfiguration message (e.g., delta signaling associated to a reference configuration or the UE's current configuration) or one or more information elements (IEs)/fields/parameters, such as CellGroupConfig. The UE performs L1 measurements (e.g., channel state information (CSI) measurements, such as synchronization signal reference signal receive power (SS-RSRP), L1 RSRP per synchronization signal block (SSB)) on these LTM candidate cells and transmits corresponding L1 measurement reports to the network (e.g., on physical uplink control channel (PUCCH) and/or physical uplink shared channel (PUSCH)). The network then triggers the execution of a LTM cell switch in the UE to one of the LTM candidate cells by transmitting an LTM cell switch command (such as a medium access control (MAC) control element (CE)), to the UE, which then connects to the particular LTM candidate cell and switches to an RRC configuration of the LTM candidate cell.

In the area of timing advance (TA) management to reduce latency for L1/L2-triggered mobility, For PDCCH ordered random access channel (RACH) for candidate cell(s), random access response (RAR) reception may be configured/indicated. If reception of RAR is not configured/indicated (without RAR), then the TA value of the candidate cell is indicated in the cell switch command. A UE can report the support combination of with RAR only and without RAR only, where support of one default scheme is the baseline UE approach for LTM. If reception of RAR is configured/indicated, RAR contains at least TA of the candidate cell. The maximum number of TA values stored by a UE is a UE capability.

UE-based TA measurement (UE derives TA based on Rx timing difference between current serving cell and candidate cell as well as TA value for the current serving cell) is supported. Corresponding UE capability will support UE-based TA measurement. For a UE that reports support of this capability, configuration of UE-based TA measurement is supported.

The MAC CE for L1/2 mobility trigger contains at least a candidate configuration index.

There currently exist certain challenges. For example, many details of the procedures for L1/L2-based inter-cell mobility are still open in 3GPP. This includes details of the LTM cell switch procedure. The UE, when configured with LTM, receives from the network at least a LTM candidate cell configuration. Further, when the LTM is executed, the UE receives a LTM cell switch command in the form of a MAC CE and triggers the LTM cell switch procedure. This command also contains the necessary information for the UE to perform the cell switch, including an indication of an LTM candidate cell configuration (e.g., LTM candidate ID) and possibly a TA value to be used in the candidate cell the UE is accessing.

As described above, the TA value of a candidate cell is indicated in cell switch command. The UE derives TA based on Rx timing difference between current serving cell and candidate cell as well as TA value for the current serving cell. In addition, the UE may use the same TA in the candidate cell as in the current serving cell. The UE performs a Random Access procedure towards the candidate cell to obtain a TA value in a Random Access Response.

### SUMMARY

As described above, certain challenges currently exist with time alignment for inter-cell mobility. For example, one problem is how the actions described above for layer one (L1)/layer two (L2) based inter-cell mobility (LTM) are signaled to a user equipment (UE), because there is no signaling for indicating to the UE anything else than a timing advance (TA) value and how the UE determines which of the actions should be triggered. Certain aspects of the present disclosure and their embodiments may provide solutions to these or other challenges. For example, particular embodiments enable a UE to receive information indicating how to handle the time alignment in a LTM candidate cell when an LTM cell switch procedure is initiated. There are two groups of embodiments.

In a first group of embodiments, information is conveyed within a medium access control (MAC) control element (CE) before or when the LTM cell switch procedure is initiated (e.g., upon reception of the LTM cell switch command or before the reception of the LTM cell switch command but after the UE is configured with an LTM candidate cell configuration). In a second group of embodiments, information is provided as part of an LTM configuration in Radio Resource Control (RRC), such as within an LTM candidate cell configuration (i.e., within an RRC message).

According to some embodiments, a method is performed by a wireless device for LTM cell switch. The method comprises receiving an indication of a timing alignment setting to use in a candidate cell. For example, the indication of the timing alignment setting may indicate how to handle time alignment in the candidate cell when an LTM switch procedure is initiated. The method further comprises performing an LTM cell switch to the candidate cell as a target cell. The wireless device may use the indicated timing alignment setting to determine how to handle time alignment in the target cell when communicating with the target cell.

In particular embodiments, receiving the indication comprises receiving a MAC CE.

In particular embodiments, the indication of the timing alignment setting indicates a TA command.

In particular embodiments, the wireless device performs one of the following actions in response to the indication of the timing alignment setting: setting a TA value for the candidate cell to an explicit value included in the indication of the timing alignment setting; setting a TA value for the candidate cell to a TA value used for a serving cell; setting a TA value for the candidate cell to a TA value used for a serving cell, adjusted by an offset; setting a TA value for the candidate cell to a TA value used for a source cell; or setting a TA value for the candidate cell to a TA value used for a source cell, adjusted by an offset.

In particular embodiments, the wireless device performs one of the following actions in response to the indication of the timing alignment setting: setting a TA value for the candidate cell to a TA value used for a timing advance group (TAG) in a source configuration; or setting a TA value for the candidate cell to a TA value used for a TAG in a source configuration, adjusted by an offset.

In particular embodiments, the wireless device performs one or more of the following actions in response to the indication of the timing alignment setting: performing a random access procedure towards the candidate cell; and not setting a TA value for the candidate cell.

In particular embodiments, the indication of the timing alignment setting is received from one of a source network node and a target network node.

In particular embodiments, the indication of the timing alignment setting is received before or during initiating a LTM cell switch procedure.

In particular embodiments, the indication of the timing alignment setting is signaled as a field in a LTM cell switch command MAC CE.

According to some embodiments, a wireless device comprises processing circuitry operable to perform any of the methods of the wireless receiver described above.

Also disclosed is a computer program product comprising a non-transitory computer readable medium storing computer readable program code, the computer readable program code operable, when executed by processing circuitry to perform any of the methods performed by the wireless device described above.

According to some embodiments, a method is performed by a network node for LTM cell switch. The method comprises determining a timing alignment setting for use in a candidate cell by a wireless device. For example, the timing alignment setting may indicate how the wireless device will handle time alignment in the candidate cell when an LTM switch procedure is initiated. The method further comprises transmitting an indication of the timing alignment setting and an indication of the candidate cell to the wireless device.

In particular embodiments, transmitting the indication comprises transmitting a MAC CE.

In particular embodiments, the indication of the timing alignment setting indicates a TA command.

In particular embodiments, the network node comprises one of a source network node and a target network node.

In particular embodiments, the indication of the timing alignment setting is transmitted before or during initiation of a LTM cell switch procedure.

In particular embodiments, the indication of the timing alignment setting is signaled as a field in a LTM cell switch command MAC CE.

According to some embodiments, a network node comprises processing circuitry operable to perform any of the methods of the network node described above.

Also disclosed is a computer program product comprising a non-transitory computer readable medium storing computer readable program code, the computer readable program code operable, when executed by processing circuitry to perform any of the methods performed by the network node described above.

Certain embodiments may provide one or more of the following technical advantages. For example, particular embodiments provide a UE with up-to-date information about how to handle a time alignment in an LTM candidate cell in an LTM cell switch procedure for the LTM candidate cell that becomes the target cell. This may enable the UE to keep the uplink synchronization with the candidate cell and thus avoid performing the random access procedure when an LTM cell switch procedure is triggered. Therefore, a benefit of particular embodiments is to reduce interruption time when switching from a source cell to a target cell, less power consumption, and less signaling overhead.

In some embodiments, for the time alignment handling the UE receives information in the LTM cell switch command indicating which method to use for time alignment in the LTM cell switch procedure. One advantage is that using one method compared to the other depends on the source and target cells, and, considering that subsequent LTM cell switch may occur, each LTM cell switch command may account for where the UE is coming from, while in RRC that would require a signaling that is not only dependent on the LTM candidate cell that is the target cell.

In some embodiments, for the time alignment handling the UE receives information in the RRC configuration for LTM (e.g., in an information element including the configuration of the LTM candidates) indicating which method to use for time alignment in the LTM cell switch procedure for an incoming cell (source cell) and target cell. One advantage is that using one method compared to the other depends on the source and target cells, and, considering that subsequent LTM cell switch may occur, each LTM cell switch command may account for where the UE is coming from in the RRC signaling, which avoids the need to define an LTM cell switch command with many options or, multiple version of the LTM cell switch command (e.g., with different logical channel identifiers).

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a block diagram illustrating the system structure, according to a particular embodiment;

FIG. 2 is an example MAC CE for time alignment, according to a particular embodiment;

FIG. 3 is another example MAC CE for time alignment, according to a particular embodiment;

FIG. 4 is another example MAC CE for time alignment, according to a particular embodiment;

FIG. 5 is another example MAC CE for time alignment, according to a particular embodiment;

FIG. 6 illustrates an example communication system, according to certain embodiments;

FIG. 7 illustrates an example user equipment (UE), according to certain embodiments;

FIG. 8 illustrates an example network node, according to certain embodiments;

FIG. 9 illustrates a block diagram of a host, according to certain embodiments;

FIG. 10 illustrates a virtualization environment in which functions implemented by some embodiments may be virtualized, according to certain embodiments;

FIG. 11 illustrates a host communicating via a network node with a UE over a partially wireless connection, according to certain embodiments;

FIG. 12 illustrates a method performed by a wireless device, according to certain embodiments; and

FIG. 13 illustrates a method performed by a network node, according to certain embodiments.

### DETAILED DESCRIPTION

As described above, certain challenges currently exist with time alignment for inter-cell mobility. Certain aspects of the present disclosure and their embodiments may provide solutions to these or other challenges. For example, particular embodiments enable a user equipment (UE) to receive information indicating how to handle the time alignment in a layer one (L1)/layer two (L2) based inter-cell mobility (LTM) candidate cell when an LTM cell switch procedure is initiated.

Particular embodiments are described more fully with reference to the accompanying drawings Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

The term “L1/L2 based inter-cell mobility” is as used in the Work Item Description in Third Generation Partnership Project (3GPP), and is interchangeably used with the terms L1/L2 mobility, L1-mobility, L1 based mobility, L1/L2-centric inter-cell mobility, L1/L2 inter-cell mobility L1/L2-Triggered Mobility, Lower-layer triggered Mobility or LTM. The basic principle is that the UE receives lower layer signaling from the network indicating to the UE a change (or switch or activation) of its serving cell (e.g., change of PCell, from a source to a target PCell), wherein lower layer signaling is a message/signaling of a lower layer protocol, which may be referred as a L1/L2 inter-cell mobility execution command or LTM cell switch command.

The change of serving cell (e.g., change of PCell) may also lead to a change in SCell(s) for the same cell group, e.g., if the command triggers the UE to change to another cell group configuration of the same type (e.g., another master cell group (MCG) configuration). Before the UE receives the LTM cell switch command, the UE is configured by the network with one or more LTM candidate cell configurations (e.g., reception of a Radio Resource Control (RRC) Reconfiguration message with at least one LTM candidate cell configuration). A LTM candidate cell configuration may include parameters in the information element (IE) CellGroupConfig for an LTM candidate cell and/or an embedded RRC Reconfiguration for an LTM candidate cell.

The term “LTM cell switch procedure” refers to the process of a UE switching (or changing) its cell from a source cell to a target cell (which may be referred to as an LTM candidate cell or a neighbor cell), using L1/L2-triggered mobility. In the context of L1/L2-triggered mobility, an LTM cell switch procedure may also be referred to as L1/L2 based inter-cell mobility execution, LTM execution, dynamic switch, LTM switch, LTM cell switch, LTM serving cell change, or LTM cell change. In particular embodiments, switching to the LTM candidate cell configuration comprises the UE considering that an LTM candidate cell becomes its new special cell (SpCell), e.g. PCell for LTM being configured for a MCG and/or PSCell for LTM being configured for a secondary cell group (SCG); or, changing its SpCell from the current PCell to an LTM candidate cell.

Even when the term “switch” or “change” of cells is used, that may comprise a switch or change of a whole cell group configuration, which includes a change in the SpCell (e.g., change of PCell, or change of PSCell), a change in SCells of the cell group (e.g., addition, modification and/or release of one or more SCells) or a swap between SpCell and SCell roles for two cells (e.g., as result of the switch or change, a first cell which was SpCell becomes an SCell and a second cell that was an SCell becomes the new SpCell).

An LTM candidate cell is a cell with which the UE is configured when configured with L1/L2-triggered mobility. The LTM candidate cell is a cell the UE can move to in a LTM cell switch procedure, upon reception of a LTM cell switch command. Such cells may also be referred to as candidate cell(s), candidates, mobility candidates, non-serving cells, additional cells, target candidate cell, target candidate, etc. A LTM candidate cell is a cell the UE may perform measurements on (e.g., channel state information (CSI) measurements) and the UE reports the measurements and the network may take educated decision on which beam (e.g., transmission configuration indicator (TCI) state) and/or cell the UE is to be switched to. An LTM candidate cell may be a candidate to be a target PCell or PSCell, or an SCell of a cell group (e.g., MCG SCell or a SCG SCell).

Particular examples refer to at least one LTM candidate cell configuration and that the UE has received at least one LTM candidate cell configuration. This may also be referred to as a configuration of a LTM candidate cell, which may be an RRC configuration, such as encapsulated in an RRC Reconfiguration message, that the UE receives when being configured with L1/L2-Triggered Mobility. A LTM candidate cell configuration comprises the configuration that the UE needs to start to operate accordingly when it performs an LTM cell switch procedure to the LTM candidate cell, e.g., upon reception of the LTM cell switch command to that LTM candidate cell, which becomes the target cell and the current (new) SpCell, or an SCell in a serving frequency.

The LTM candidate cell configuration comprises parameters of a serving cell (or multiple serving cells, such as a cell group), comprising one or more of the groups of parameters, such as an RRCReconfiguration message an IE CellGroupConfig or an IE SpCellConfig (or the IE SCellConfig for a Secondary Cell). An LTM candidate cell configuration may, in one example, comprise one or more of: i) the PCell configuration and one or more SCell configuration(s) of a MCG; i) the PSCell configuration and one or more SCell configuration(s) of a SCG. The terms LTM candidate configuration, LTM configuration, LTM candidate target cell configuration, LTM target candidate (cell) configuration may be used interchangeably when referring to LTM candidate cell configuration.

The actual LTM candidate cell configuration and its content and/or structure of the IE and/or embedded message may be referred to as an RRC model for the candidate configuration, or simply RRC model. An LTM candidate cell configuration comprises the configuration that the UE needs to operate accordingly when it performs (executes) L1/L2 based inter-cell mobility execution to a LTM candidate cell, upon reception of the lower layer signaling (medium access control (MAC) control element (CE)) indicating a L1/L2 based inter-cell mobility to a LTM candidate cell (which becomes the target cell and the current (new) PCell, or an SCell in a serving frequency), or upon reception of the lower layer signaling (MAC CE) indicating a L1/L2 based inter-cell mobility to a LTM candidate cell configuration indicated with a candidate configuration identifier, identity or index (also referred to as candidate configuration ID).

The UE may be configured with multiple LTM candidate cell configurations. A Candidate DU (C-DU) generates and sends to the CU multiple configuration(s). The actual LTM candidate cell configuration the UE receives during the LTM configuration may be a delta signaling to be applied on top of a reference configuration. The actual configuration the UE is to use in the LTM candidate cell upon LTM cell switch is the combination of the LTM candidate cell configuration and the reference configuration (e.g., separately signaled by the network to the UE). The combination of the LTM candidate cell configuration and the reference configuration the UE uses may also be referred to as a complete LTM candidate cell configuration. As used herein, unless stated otherwise, the complete LTM candidate cell configuration may also be considered as an LTM candidate cell configuration.

A serving cell is a cell configured for the UE, for example an SpCell, PCell, PSCell or SCell. A source cell is a cell configured as a serving cell for the UE prior to the execution of the LTM cell switch procedure. A target cell is a cell configured as a serving cell, for example an SpCell, PCell, PSCell or SCell, for the UE after, or as a result of, the execution of the LTM cell switch procedure, which may include a cell indicated in the LTM cell switch command indicating to the UE the LTM cell switch procedure or a cell configured as result of the UE switching to the LTM candidate cell configuration provided by an indication of an LTM candidate cell configuration, also sometimes referred to as a candidate configuration index, an LTM configuration index or an LTM candidate cell index, in the LTM cell switch command. In the context of a LTM cell switch procedure executed by the UE, a given cell may be either a source cell, a target cell, both a source cell and target cell or neither a source cell nor a target cell.

A source configuration refers to the UE configuration when receiving the LTM cell switch command indicating to the UE the LTM cell switch procedure.

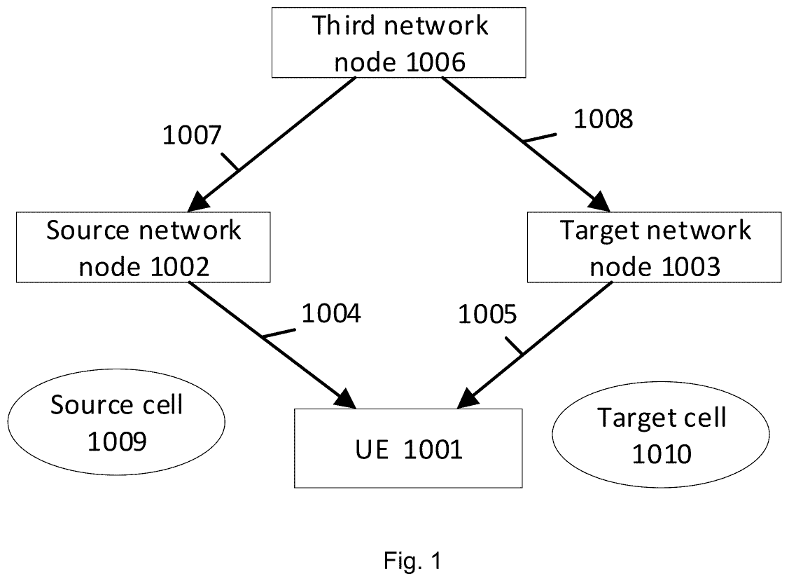

FIG. 1 is a block diagram illustrating the system structure, according to a particular embodiment. FIG. 1 illustrates a system structure including the entities involved in particular embodiments. UE 1001 is a wireless terminal, such as a cellular smartphone, sometimes connected to the source network node 1002 over a wireless interface 1004 and sometimes connected to a target network node 1003, to which the UE 1001 is connected over a wireless interface 1005.

In the context of a mobility procedure, such as a LTM cell switch procedure, for the UE, source network node 1002, also referred to as the serving network node, controls a source cell 1009 (also referred to as serving cell or Special Cell (SpCell)). Target network node 1003 controls a target cell 1010 (also referred to as neighbor cell, candidate cell or LTM candidate cell). Each of source network node 1002 and target network node 1003 may be a base station such as, e.g. gNB, or, e.g. in case of a distributed CU/DU radio access network (RAN) architecture, a distributed unit, also referred to as either gNB-DU or DU. Thus, source network node 1002 corresponds to a source DU, S-DU, also referred to as serving DU, and target network node 1003 corresponds to a target DU, T-DU (also referred to as neighbor DU or candidate DU, C-DU). Both source network node 1002 and target network node 1003 are connected to a third network node 1006, also referred to as serving network node. The source network node and the target network node may be the same network node. In some scenarios, source network node 1002 and target network node 1003 may be connected to different third network nodes 1006.

Further, third network node 1006 may, e.g. for a distributed CU/DU RAN architecture, be a central unit, CU, also referred to as the serving CU, known as either a gNB-CU, CU, gNB-CU-CP or gNB-CU-UP, or a core network node such as an User Plane Function (UPF) or an Access and Mobility management Function (AMF).

According to some embodiments, a method is performed by a UE for using timing advance (TA) comprising receiving information related to time alignment setting and an indication of a candidate cell. In particular embodiments, the information related to time alignment setting is a lower layer signaling, such as a MAC CE. In particular embodiments, the information related to time alignment setting indicates a TA command. In other embodiments, the information related to time alignment setting does not indicate a TA command.

In particular embodiments, the UE performs one of the following actions in response to the information related to time alignment setting: (a) setting the TA value for the indicated candidate cell to an explicit value included in the information related to time alignment setting; (b) setting the TA value for the indicated candidate cell to the TA value used for the serving cell; (c) setting the TA value for the indicated candidate cell to the TA value used for the serving cell, adjusted by an offset; (d) setting the TA value for the indicated candidate cell to the TA value used for a source cell; (e) setting the TA value for the indicated candidate cell to the TA value used for a source cell, adjusted by an offset; (f) setting the TA value for the indicated candidate cell to the TA value used for a Timing Advance Group (TAG) in the source configuration; (g) setting the TA value for the indicated candidate cell to the TA value used for a TAG in the source configuration, adjusted by an offset; (h) performing a random access procedure towards the indicated candidate cell; and/or (i) not set a TA value for the indicated candidate cell.

In particular embodiments, the UE receives signaling to adjust the TA from a source network node and/or a target network node. In particular embodiments, the UE receives a signaling to adjust the TA before or during initiating a LTM cell switch procedure.

In particular embodiments, the indicated candidate cell is an indication of an LTM candidate cell configuration, such a candidate configuration index, an LTM configuration index or an LTM candidate cell index. The indicated candidate cell may be a group of cells, such as a CellGroupConfig, a MCG or a SCG. The indicated candidate cell may be either an SpCell or an SCell, or a serving or source cell is either an SpCell or an SCell, or the indicated candidate and serving or source cells are different cells, e.g., use different physical cell identities or use different cell configurations, or the indicated candidate and serving or source cells are the same cell, e.g., use same physical cell identity or use same cell configuration.

Some embodiments include MAC CE embodiments. In particular embodiments, the information related to time alignment setting is signaled as a field in a MAC CE. In particular embodiments, the MAC CE that includes the information related to time alignment setting is a different MAC CE than the one used for initiating an LTM cell switch procedure. In some embodiments, the MAC CE that includes the information related to time alignment setting is sent to the UE separately from the MAC CE than the one used for initiating an LTM cell switch procedure. In this case, the UE acquires this information before a LTM cell switch procedure is initiated.

In particular embodiments, the MAC CE that includes the information related to time alignment setting is multiplexed in the same MAC protocol data unit (PDU) with the MAC CE as the one used for initiating an LTM cell switch procedure. In such a case, the UE acquires this information at the time an LTM cell switch procedure is triggered.

In particular embodiments, the indication of no TA command is indicated by a MAC CE with a logical channel identifier (LCID) that indicates the TA command is not included.

In particular embodiments, the setting of the TA value for the indicated candidate cell to the TA value used for the serving cell is signaled as a field in a MAC CE. In particular embodiments, the setting of the TA value for the indicated candidate cell to the TA value used for the serving cell adjusted by an offset is signaled as a field in a MAC CE.

In particular embodiments, the offset is signaled in the MAC CE, is calculated by the UE, and/or the offset is calculated based on the propagation delay difference between the serving and target cells,

In particular embodiments, the random access procedure is triggered by a field in a MAC CE.

In particular embodiments, a special value of the explicit value indicates that the UE shall set the TA value for the target cell to the TA value used for the serving cell. The special value of the explicit value may indicate that the UE shall set the TA value for the target cell to the TA value used for the serving cell, adjusted by an offset. The offset may be calculated by the UE, and/or may be based on the propagation delay difference between the serving and target cells.

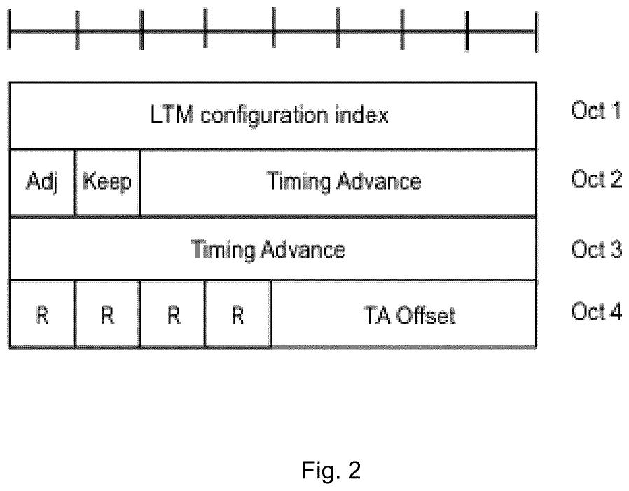

FIG. 2 is an example MAC CE for time alignment, according to a particular embodiment. The illustrated example (Implementation MAC CE 1) is a MAC CE format to indicate the UE to adjust the TA. In the illustrated implementation, the UE receives a MAC CE that comprises the following fields:
“LTM configuration index”: This field indicates the LTM candidate cell (target cell) or the LTM candidate cell configuration to which the adjustment of the TA applies.
“Adj”: This field indicates to the UE that the TA value for the LTM candidate cell indicated within the “LTM configuration index” field should be adjusted by a offset value given in the field “TA Offset”. For example, value 0 indicates that the UE should not adjust the TA value and value 1 indicates that the UE should adjust the TA value.
“Keep”: This field indicates that the TA value for the LTM candidate cell indicated within the “LTM configuration index” field should be kept as it is. For example, value 0 indicates that the UE should not keep the current TA value and value 1 indicates that the UE should keep the TA value.
“Time Advance”: This field indicates the TA value for the UE to be applied for the LTM candidate cell indicated within the “LTM configuration index” field. For example value 0000000000000 indicates to the UE that the TA value of the serving cell should be applied as TA value for the LTM candidate cell indicated within the “LTM configuration index” field.
“TA Offset”: This field indicates the offset to be applies on the current TA for the LTM candidate cell indicated within the “LTM configuration index” field. Value 0000 means that no offset should be applied.

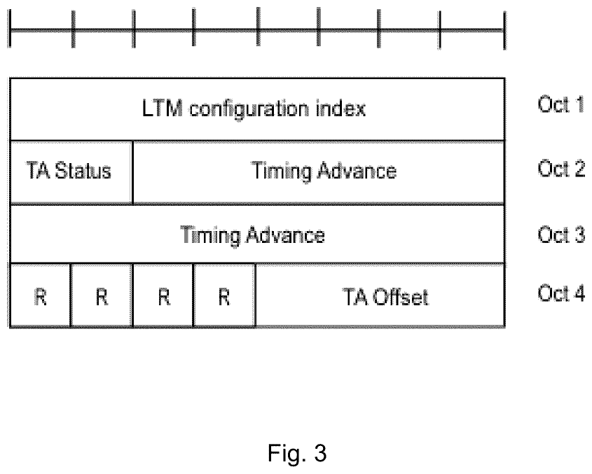

FIG. 3 is another example MAC CE for time alignment, according to a particular embodiment. In the illustrated example (Implementation MAC CE 2), the UE receives a MAC CE that comprises the following fields:
“LTM configuration index”: This field indicates the LTM candidate cell (target cell) or the LTM candidate cell configuration to which the adjustment of the TA applies.
“TA status”: This field indicates to the UE whether the TA value for the LTM candidate cell indicated within the “LTM configuration index” field should be adjusted by a offset value given in the field “TA Offset” or whether the TA value for the LTM candidate cell indicated within the “LTM configuration index” field should be kept as it is. For example, value 00 indicate that this field should be ignored by the UE, value 10 indicates that the TA value for the LTM candidate cell indicated within the “LTM configuration index” field should be adjusted by a offset value given in the field “TA Offset”, value 01 indicates that the TA value for the LTM candidate cell indicated within the “LTM configuration index” field should be kept as it is and value 11 is reserved for future use.
“Time Advance”: This field indicates the TA value for the UE to be applied for the LTM candidate cell indicated within the “LTM configuration index” field. For example value 0000000000000 indicates to the UE that the TA value of the serving cell should be applied as TA value for the LTM candidate cell indicated within the “LTM configuration index” field.
“TA Offset”: This field indicates the offset to be applies on the current TA for the LTM candidate cell indicated within the “LTM configuration index” field. Value 0000 means that no offset should be applied.

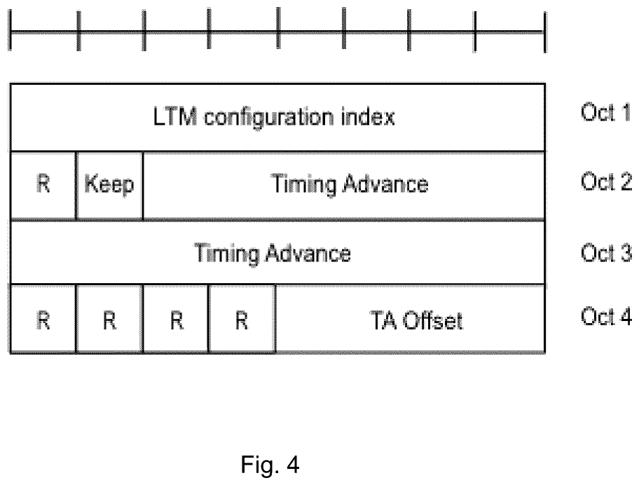

FIG. 4 is another example MAC CE for time alignment, according to a particular embodiment. In the illustrated example (Implementation MAC CE 3), the UE receives a MAC CE that comprises the following fields:
“LTM configuration index”: This field indicates the LTM candidate cell (target cell) or the LTM candidate cell configuration to which the adjustment of the TA applies.
“Adj”: This field indicates to the UE that the TA value for the LTM candidate cell indicated within the “LTM configuration index” field should be adjusted by a offset value given in the field “TA Offset”. For example, value 0 indicates that UE should not adjust the TA value and value 1 indicates that UE should adjust the TA value.
“Keep”: This field indicates that the TA value for the LTM candidate cell indicated within the “LTM configuration index” field should be kept as it is. For example, value 0 indicates that the UE should not keep the current TA value and value 1 indicates that the UE should keep the TA value.
“Time Advance”: This field indicates the TA value for the UE to be applied for the LTM candidate cell indicated within the “LTM configuration index” field. For example value 0000000000000 indicates to the UE that the TA value of the serving cell should be applied as TA value for the LTM candidate cell indicated within the “LTM configuration index” field.
“TA Offset”: This field indicates to the UE that the TA value for the LTM candidate cell indicated within the “LTM configuration index” field should be adjusted by the TA offset value provided. Value 0000 means that no offset should be applied.

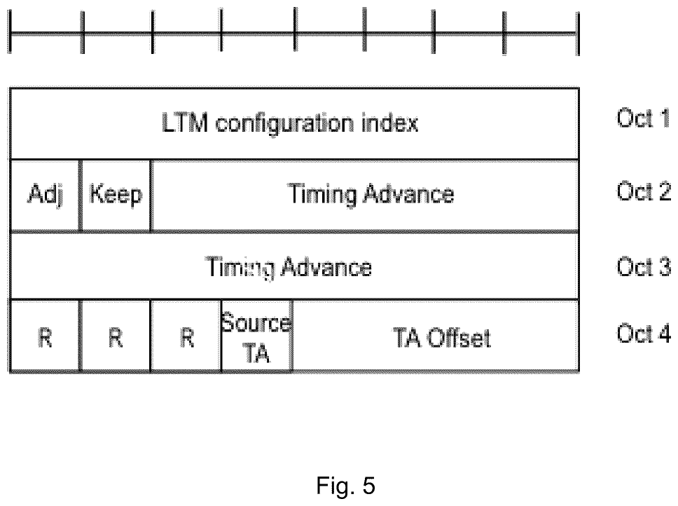

FIG. 5 is another example MAC CE for time alignment, according to a particular embodiment. In the illustrated example (Implementation MAC CE 4), the UE receives a MAC CE that comprises the following fields:
“LTM configuration index”: This field indicates the LTM candidate cell (target cell) or the LTM candidate cell configuration to which the adjustment of the TA applies.
“Adj”: This field indicates to the UE that the TA value for the LTM candidate cell indicated within the “LTM configuration index” field should be adjusted by a offset value given in the field “TA Offset”. For example, value 0 indicates that UE should not adjust the TA value and value 1 indicates that UE should adjust the TA value.
“Keep”: This field indicates that the TA value for the LTM candidate cell indicated within the “LTM configuration index” field should be kept as it is. For example, value 0 indicates that the UE should not keep the current TA value and value 1 indicates that the UE should keep the TA value.
“Time Advance”: This field indicates the TA value for the UE to be applied for the LTM candidate cell indicated within the “LTM configuration index” field. For example, value 0000000000000 indicates to the UE that the TA value of the serving cell should be applied as TA value for the LTM candidate cell indicated within the “LTM configuration index” field.
“Source TA”: This field indicate to the UE that the TA value of the serving cell should be applied as TA value for the LTM candidate cell indicated within the “LTM configuration index” field.
“TA Offset”: This field indicates to the UE that the TA value for the LTM candidate cell indicated within the “LTM configuration index” field should be adjusted by the TA offset value provided. Value 0000 means that no offset should be applied.

Some embodiments include RRC embodiments. In particular embodiments, the UE determines that it should set the TA value for the indicated candidate cell to the TA value used for a serving cell or a source cell based on the indication of a candidate cell. The serving cell or source cell may be an SpCell and/or an SCell.

In particular embodiments, the indication of a candidate cell is an indication of an LTM candidate cell configuration, such as a candidate configuration index, an LTM configuration index or an LTM candidate cell index.

In particular embodiments, the UE determines that it should set the TA value for the indicated candidate cell to the TA value used for a serving or a source cell adjusted by an offset based on the indication of a candidate cell. The serving cell or source cell may be an SpCell and/or an SCell.

In particular embodiments, the indication of a candidate cell is an indication of an LTM candidate cell configuration, such as a candidate configuration index, an LTM configuration index or an LTM candidate cell index.

In particular embodiments, the offset is provided as part of an LTM candidate cell configuration, is calculated by the UE, and/or is calculated based on the propagation delay difference between the serving and target cells.

In particular embodiments, the random access procedure is triggered based on the candidate cell index.

The following are example RRC implementations to indicate the UE to adjust the TA.

### RRC Implementation, Example 1:

### PhysicalCellGroupConfig

The IE PhysicalCellGroupConfig is used to configure cell-group specific L1 parameters.

### PhysicalCellGroupConfig Information Element

-- ASN1START
-- TAG-PHYSICALCELLGROUPCONFIG-START

| | |
|---|---|
| PhysicalCellGroupConfig ::= | SEQUENCE { |

[...]
[[

| | |
|---|---|
| ltm-TimeAlignmentInfo-r18 | SetupRelease {LTM-TimeAlignmentInfo-r18} OPTIONAL, - |

- Need M
]]
}
[...]
LTM-TimeAlignmentInfo-r18 ::= SEQUENCE {

| | |
|---|---|
| ltm-CandidateCellIndex | LTM-CandidateCellIndex |

OPTIONAL,

| | |
|---|---|
| ta-Adjust-r18 | ENUMERATED {true} |

OPTIONAL,

| | |
|---|---|
| ta-Keep-r18 | ENUMERATED {true} |

OPTIONAL,

| | |
|---|---|
| ta-Value-r18 | INTEGER (1..999999999) OPTIONAL, |
| ta-Offset-r18 | INTEGER (0..999999999) OPTIONAL, |

}
-- TAG-PHYSICALCELLGROUPCONFIG-STOP
-- ASN1STOP

LTM-TimeAlignment field descriptions

ltm-CandidateCellIndex
This field indicates the LTM candidate cell index for which the TA info within LTM-
TimeAligmentInfo IE applies.
ta-Adjust
This field indicates to the UE that the TA value for this LTM candidate cell should be
adjusted by an offset value given in the field ta-offset.
ta-Keep
This field indicates that the TA value for this LTM candidate cell, if UE already received
one, should be kept as it is
ta-Value
This field indicates the TA value to be applied for this LTM candidate cell. Value “xxxx”
indicates that the TA value of the serving cell should be applied as TA value for this LTM
candidate cell.
ta-Offset
This field indicates the offset to be applied on the current TA for this LTM candidate cell.

In example 1, the UE receives a RRC reconfiguration (e.g., within the PhysicalCellGroupConfig IE) that comprises the following fields:
“Itm-CandidateCellIndex”: This field indicates the LTM candidate cell (target cell) to which the adjustment of the TA applies.
“ta-Adjust”: This field indicates to the UE that the TA value for the LTM candidate cell should be adjusted by a offset value given in the field “ta-Offset”. For example, the absence of the field indicates that UE should not adjust the TA value and value “true” indicates that UE should adjust the TA value.
“ta-Keep”: This field indicates that the TA value for the LTM candidate cell should be kept as it is. For example, the absence of the field indicates that the UE should not keep the current TA value and value “true” indicates that the UE should keep the TA value.
“ta-Value”: This field indicates the TA value for the UE to be applied for the LTM candidate cell. For example value 0000000000000 indicates to the UE that the TA value of the serving cell should be applied as TA value for the LTM candidate cell indicated within the “LTM configuration index” field.
“ta-Offset”: This field indicates the offset to be applied on the current TA for the LTM candidate cell. Value 0 means that no offset should be applied.

### RRC Implementation, Example 2:

### PhysicalCellGroupConfig

The IE PhysicalCellGroupConfig is used to configure cell-group specific L1 parameters.

### PhysicalCellGroupConfig Information Element

-- ASN1START
-- TAG-PHYSICALCELLGROUPCONFIG-START

| | |
|---|---|
| PhysicalCellGroupConfig ::= | SEQUENCE { |

[...]
[[

| | |
|---|---|
| ltm-TimeAlignmentInfo-r18 | SetupRelease {LTM-TimeAlignmentInfo-r18} OPTIONAL, - |

- Need M
]]
}
[...]
LTM-TimeAlignmentInfo-r18 ::= SEQUENCE {

| | |
|---|---|
| ltm-CandidateCellIndex | LTM-CandidateCellIndex |

OPTIONAL,

| | |
|---|---|
| Ta-Status-r18 | ENUMERATED {keep, adjust} |

OPTIONAL,

| | |
|---|---|
| ta-Value-r18 | INTEGER (1..999999999) OPTIONAL, |
| ta-Offset-r18 | INTEGER (0..999999999) OPTIONAL, |

}
-- TAG-PHYSICALCELLGROUPCONFIG-STOP
-- ASN1STOP

LTM-TimeAlignment field descriptions

ltm-CandidateCellIndex
This field indicates the LTM candidate cell index for which the TA info within LTM-
TimeAligmentInfo IE applies.
ta-Status
This field indicates whether the UE should keep or adjust the TA value for this LTM
candidate cell. Value adjust indicates to the UE that the TA value for this LTM candidate
cell should be adjusted by an offset value given in the field ta-offset whereas value keep
indicates that the TA value for this LTM candidate cell, if UE already received one, should
be kept as it is
ta-Value
This field indicates the TA value to be applied for this LTM candidate cell. Value “xxxx”
indicates that the TA value of the serving cell should be applied as TA value for this LTM
candidate cell.
ta-Offset
This field indicates the offset to be applied on the current TA for this LTM candidate cell.

In example 2, the UE receives a RRC reconfiguration (e.g., within the PhysicalCellGroupConfig IE) that comprises the following fields:
“ltm-CandidateCellIndex”: This field indicates the LTM candidate cell (target cell) to which the adjustment of the TA applies.
“ta-Status”: This field indicates to the UE whether the TA value for the LTM candidate cell should be adjusted by a offset value given in the field “ta-Offset” or whether the TA value for the LTM candidate cell should be kept as it is. For example, value “adjust” indicates that the TA value for the LTM candidate cell should be adjusted by a offset value given in the field “ta-Offset”, and value “keep” indicates that the TA value for the LTM candidate cell should be kept as it is.
“ta-Value”: This field indicates the TA value for the UE to be applied for the LTM candidate cell.
“ta-Offset”: This field indicates the offset to be applied on the current TA for the LTM candidate cell. Value 0 means that no offset should be applied.

### RRC Implementation, Example 3:

### PhysicalCellGroupConfig

The IE PhysicalCellGroupConfig is used to configure cell-group specific L1 parameters.

### PhysicalCellGroupConfig Information Element

-- ASN1START
-- TAG-PHYSICALCELLGROUPCONFIG-START

| | |
|---|---|
| PhysicalCellGroupConfig ::= | SEQUENCE { |

[...]
[[

| | |
|---|---|
| ltm-TimeAlignmentInfo-r18 | SetupRelease {LTM-TimeAlignmentInfo-r18} |

OPTIONAL, -- Need M
]]
[...]
}
[...]
LTM-TimeAlignmentInfo-r18 ::= SEQUENCE {

| | |
|---|---|
| ltm-CandidateCellIndex | LTM-CandidateCellIndex |

OPTIONAL,

| | |
|---|---|
| ta-Keep-r18 | ENUMERATED {true} |

OPTIONAL,

| | |
|---|---|
| ta-Value-r18 | INTEGER (1..999999999) OPTIONAL, |
| ta-Offset-r18 | INTEGER (1..999999999) OPTIONAL, |

}
-- TAG-PHYSICALCELLGROUPCONFIG-STOP
-- ASN1STOP

LTM-TimeAlignment field descriptions

ltm-CandidateCellIndex
This field indicates the LTM candidate cell index for which the TA info within LTM-
TimeAligmentInfo IE applies.
ta-Keep
This field indicates that the TA value for this LTM candidate cell, if UE already received
one, should be kept as it is.
ta-Value
This field indicates the TA value to be applied for this LTM candidate cell. Value “xxxx”
indicates that the TA value of the serving cell should be applied as TA value for this LTM
candidate cell.
ta-Offset
This field indicates the offset to be applied on the current TA for this LTM candidate cell.

In example 3, the UE receives a RRC reconfiguration (e.g., within the PhysicalCellGroupConfig IE) that comprises the following fields:
“ltm-CandidateCellIndex”: This field indicates the LTM candidate cell (target cell) to which the adjustment of the TA applies.
“ta-Keep”: This field indicates that the TA value for the LTM candidate cell should be kept as it is. For example, the absence of the field indicates that the UE should not keep the current TA value and value “true” indicates that the UE should keep the TA value.
“ta-Value”: This field indicates the TA value for the UE to be applied for the LTM candidate cell. For example value 0000000000000 indicates to the UE that the TA value of the serving cell should be applied as TA value for the LTM candidate cell indicated within the “LTM configuration index” field.
“ta-Offset”: This field indicates the offset to be applies on the current TA for the LTM candidate cell. Value 0 means that no offset should be applied.

### RRC Implementation, Example 4:

### PhysicalCellGroupConfig

The IE PhysicalCellGroupConfig is used to configure cell-group specific L1 parameters.

### PhysicalCellGroupConfig Information Element

-- ASN1START
-- TAG-PHYSICALCELLGROUPCONFIG-START

| | |
|---|---|
| PhysicalCellGroupConfig ::= | SEQUENCE { |

[...]
[[

| | |
|---|---|
| ltm-TimeAlignment Info-r18 | SetupRelease {LTM-TimeAlignmentInfo-r18} |

OPTIONAL, -- Need M
]]
[...]
}
[...]
LTM-TimeAlignmentInfo-r18 ::= SEQUENCE {

| | |
|---|---|
| ltm-CandidateCellIndex | LTM-CandidateCellIndex |

OPTIONAL,

| | |
|---|---|
| ta-Adjust-r18 | ENUMERATED {true} |

OPTIONAL,

| | |
|---|---|
| ta-Keep-r18 | ENUMERATED {true} |

OPTIONAL,

| | |
|---|---|
| ta-Value-r18 | INTEGER (1..999999999) OPTIONAL, |
| ta-Source-r18 | ENUMERATED {true} |

OPTIONAL,

| | |
|---|---|
| ta-Offset-r18 | INTEGER (0..999999999) OPTIONAL, |

}
-- TAG-PHYSICALCELLGROUPCONFIG-STOP
-- ASN1STOP

LTM-TimeAlignment field descriptions

ltm-CandidateCellIndex
This field indicates the LTM candidate cell index for which the TA info within LTM-
TimeAligmentInfo IE applies.
ta-Adjust
This field indicates to the UE that the TA value for this LTM candidate cell should be
adjusted by an offset value given in the field ta-offset.
ta-Keep
This field indicates that the TA value for this LTM candidate cell, if UE already received
one, should be kept as it is
ta-Value
This field indicates the TA value to be applied for this LTM candidate cell. Value “xxxx”
indicates that the TA value of the serving cell should be applied as TA value for this LTM
candidate cell.
ta-Source
This field indicates that the TA value of the serving cell should be applied as TA value for
this LTM candidate cell.
ta-Offset
This field indicates the offset to be applied on the current TA for this LTM candidate cell.

In example 4, the UE receives a RRC reconfiguration (e.g., within the PhysicalCellGroupConfig IE) that comprises the following fields:
“ltm-CandidateCellIndex”: This field indicates the LTM candidate cell (target cell) to which the adjustment of the TA applies.
“ta-Adjust”: This field indicates to the UE that the TA value for the LTM candidate cell should be adjusted by a offset value given in the field “ta-Offset”. For example, the absence of the field indicates that UE should not adjust the TA value and value “true” indicates that UE should adjust the TA value.
“ta-Keep”: This field indicates that the TA value for the LTM candidate cell should be kept as it is. For example, the absence of the field indicates that the UE should not keep the current TA value and value “true” indicates that the UE should keep the TA value.
“ta-Value”: This field indicates the TA value for the UE to be applied for the LTM candidate cell. For example value 0000000000000 indicates to the UE that the TA value of the serving cell should be applied as TA value for the LTM candidate cell indicated within the “LTM configuration index” field.
“ta-Source”: This field indicates that the TA value of the serving cell should be applied as TA value for this LTM candidate cell.
“ta-Offset”: This field indicates the offset to be applied on the current TA for the LTM candidate cell. Value 0 means that no offset should be applied.

### RRC Implementation, Example 5:

### PhysicalCellGroupConfig

The IE PhysicalCellGroupConfig is used to configure cell-group specific L1 parameters.

### PhysicalCellGroupConfig Information Element

-- ASN1START
-- TAG-PHYSICALCELLGROUPCONFIG-START

| | |
|---|---|
| PhysicalCellGroupConfig ::= | SEQUENCE { |

[...]
[[

| | |
|---|---|
| ltm-TimeAlignmentInfo-r18 | SetupRelease {LTM-TimeAlignmentInfo-r18} |

OPTIONAL, -- Need M
]]
}
[...]
LTM-TimeAlignmentInfo-r18 ::= SEQUENCE {

| | |
|---|---|
| ltm-CandidateCellIndex | LTM-CandidateCellIndex |

OPTIONAL,

| | |
|---|---|
| ta-Adjust-r18 | ENUMERATED {true} |

OPTIONAL,

| | |
|---|---|
| ta-Keep-r18 | ENUMERATED {true} |

OPTIONAL,

| | |
|---|---|
| ta-Value-r18 | INTEGER (1..999999999) OPTIONAL, |
| ta-Source-r18 | CHOICE { |
| spCell | NULL, |
| sCell | SCellIndex |
| } | OPTIONAL, |
| ta-Offset-r18 | INTEGER (0..999999999) OPTIONAL, |

}
-- TAG-PHYSICALCELLGROUPCONFIG-STOP
-- ASN1STOP

LTM-TimeAlignment field descriptions

ltm-CandidateCellIndex
This field indicates the LTM candidate cell index for which the TA info within LTM-
TimeAligmentInfo IE applies.
ta-Adjust
This field indicates to the UE that the TA value for this LTM candidate cell should be
adjusted by an offset value given in the field ta-offset.
ta-Keep
This field indicates that the TA value for this LTM candidate cell, if UE already received
one, should be kept as it is
ta-Value
This field indicates the TA value to be applied for this LTM candidate cell. Value “xxxx”
indicates that the TA value of the serving cell should be applied as TA value for this LTM
candidate cell.
ta-Source
This field indicates that the TA value of a source cell should be applied as TA value for
this LTM candidate cell. A value of spCell indicates to use the TA value of the source
SpCell. A value of sCell indicates to use the TA value of the source SCell indicated by
SCellIndex.
ta-Offset
This field indicates the offset to be applied on the current TA for this LTM candidate cell.

In example 5, the UE receives a RRC reconfiguration (e.g., within the PhysicalCellGroupConfig IE) that comprises the following fields:
“Itm-CandidateCellIndex”: This field indicates the LTM candidate cell (target cell) to which the adjustment of the TA applies.
“ta-Adjust”: This field indicates to the UE that the TA value for the LTM candidate cell should be adjusted by a offset value given in the field “ta-Offset”. For example, the absence of the field indicates that UE should not adjust the TA value and value “true” indicates that UE should adjust the TA value.
“ta-Keep”: This field indicates that the TA value for the LTM candidate cell should be kept as it is. For example, the absence of the field indicates that the UE should not keep the current TA value and value “true” indicates that the UE should keep the TA value.
“ta-Value”: This field indicates the TA value for the UE to be applied for the LTM candidate cell. For example value 0000000000000 indicates to the UE that the TA value of the serving cell should be applied as TA value for the LTM candidate cell indicated within the “LTM configuration index” field.
“ta-Source”: This field indicates that the TA value of a source cell (source SpCell or an indicated source SCell) should be applied as TA value for this LTM candidate cell.
“ta-Offset”: This field indicates the offset to be applied on the current TA for the LTM candidate cell. Value 0 means that no offset should be applied.

### RRC Implementation, Example 6:

### PhysicalCellGroupConfig

The IE PhysicalCellGroupConfig is used to configure cell-group specific L1 parameters.

### PhysicalCellGroupConfig Information Element

-- ASN1START
-- TAG-PHYSICALCELLGROUPCONFIG-START

| | |
|---|---|
| PhysicalCellGroupConfig ::= | SEQUENCE { |

[...]
[[

| | |
|---|---|
| ltm-TimeAlignmentInfo-r18 | SetupRelease {LTM-TimeAlignmentInfo-r18} |

OPTIONAL, -- Need M
]]
}
[...]
LTM-TimeAlignmentInfo-r18 ::= SEQUENCE {

| | |
|---|---|
| ltm-CandidateCellIndex | LTM-CandidateCellIndex |

OPTIONAL,

| | |
|---|---|
| ta-Adjust-r18 | ENUMERATED {true} |

OPTIONAL,

| | |
|---|---|
| ta-Keep-r18 | ENUMERATED {true} |

OPTIONAL,

| | |
|---|---|
| ta-Value-r18 | INTEGER (1..999999999) OPTIONAL, |
| ta-Source-r18 | TAG-Id OPTIONAL, |
| ta-Offset-r18 | INTEGER (0..999999999) OPTIONAL, |

}
-- TAG-PHYSICALCELLGROUPCONFIG-STOP
-- ASN1STOP

LTM-TimeAlignment field descriptions

ltm-CandidateCellIndex
This field indicates the LTM candidate cell index for which the TA info within LTM-
TimeAligmentInfo IE applies.
ta-Adjust
This field indicates to the UE that the TA value for this LTM candidate cell should be
adjusted by a offset value given in the field ta-offset.
ta-Keep
This field indicates that the TA value for this LTM candidate cell, if UE already received
one, should be kept as it is
ta-Value
This field indicates the TA value to be applied for this LTM candidate cell. Value “xxxx”
indicates that the TA value of the serving cell should be applied as TA value for this LTM
candidate cell.
ta-Source
This field indicates that the TA value of the indicated TAG in the source configuration
should be applied for this LTM candidate cell.
ta-Offset
This field indicates the offset to be applied on the current TA for this LTM candidate cell.

In example 6, the UE receives a RRC reconfiguration (e.g., within the PhysicalCellGroupConfig IE) that comprises the following fields:
“ltm-CandidateCellIndex”: This field indicates the LTM candidate cell (target cell) to which the adjustment of the TA applies.
“ta-Adjust”: This field indicates to the UE that the TA value for the LTM candidate cell should be adjusted by a offset value given in the field “ta-Offset”. For example, the absence of the field indicates that UE should not adjust the TA value and value “true” indicates that UE should adjust the TA value.
“ta-Keep”: This field indicates that the TA value for the LTM candidate cell should be kept as it is. For example, the absence of the field indicates that the UE should not keep the current TA value and value “true” indicates that the UE should keep the TA value.
“ta-Value”: This field indicates the TA value for the UE to be applied for the LTM candidate cell. For example value 0000000000000 indicates to the UE that the TA value of the serving cell should be applied as TA value for the LTM candidate cell indicated within the “LTM configuration index” field.
“ta-Source”: This field indicates that the TA value of a source cell (source SpCell or an indicated source SCell) should be applied as TA value for this LTM candidate cell.
“ta-Offset”: This field indicates the offset to be applied on the current TA for the LTM candidate cell. Value 0 means that no offset should be applied.

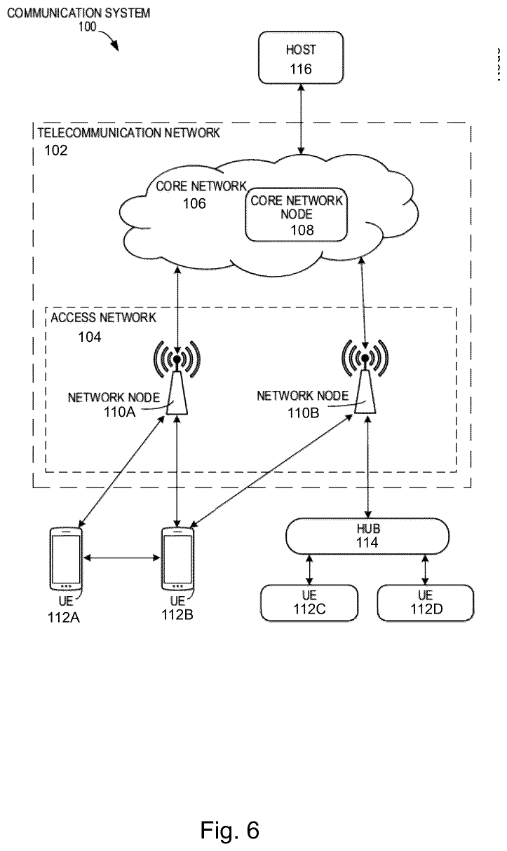

FIG. 6 illustrates an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3rd Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more services. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 6 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

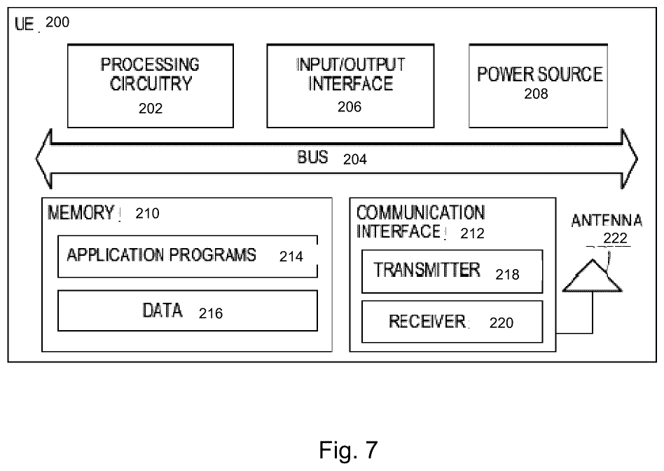

FIG. 7 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 7.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

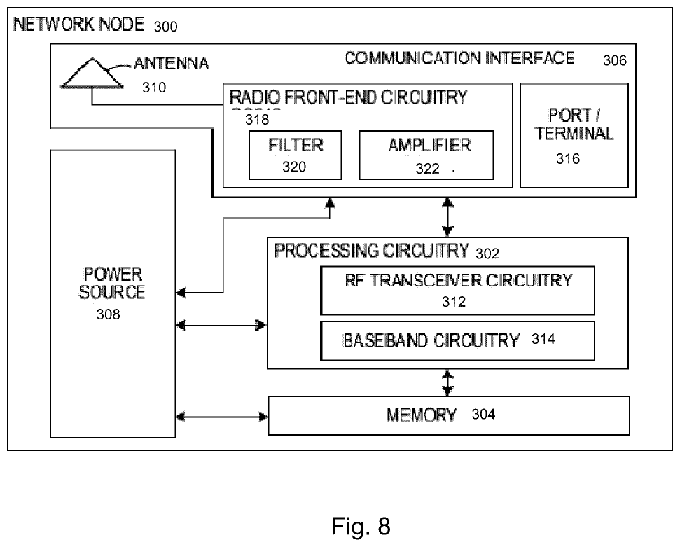

FIG. 8 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 8 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

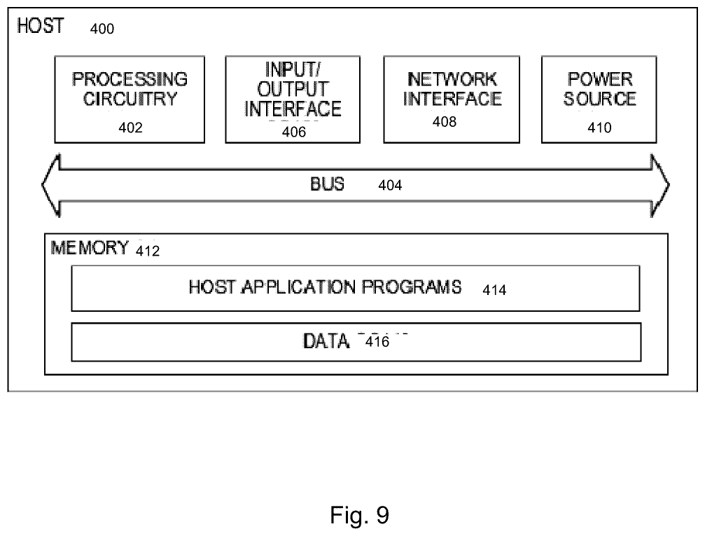

FIG. 9 is a block diagram of a host 400, which may be an embodiment of the host 116 of FIG. 6, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 3 and 4, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

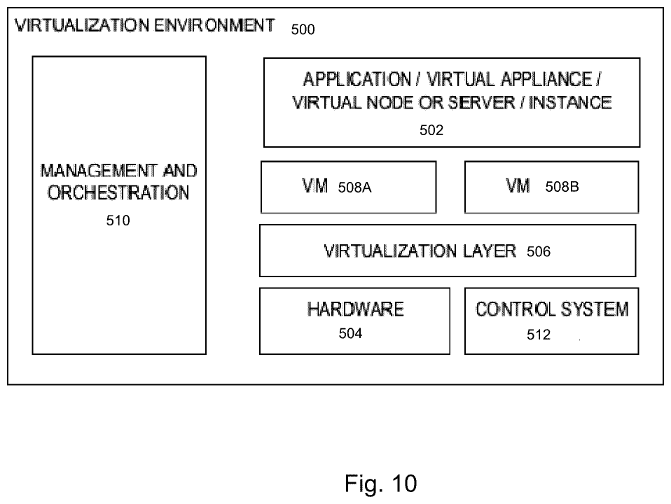

FIG. 10 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

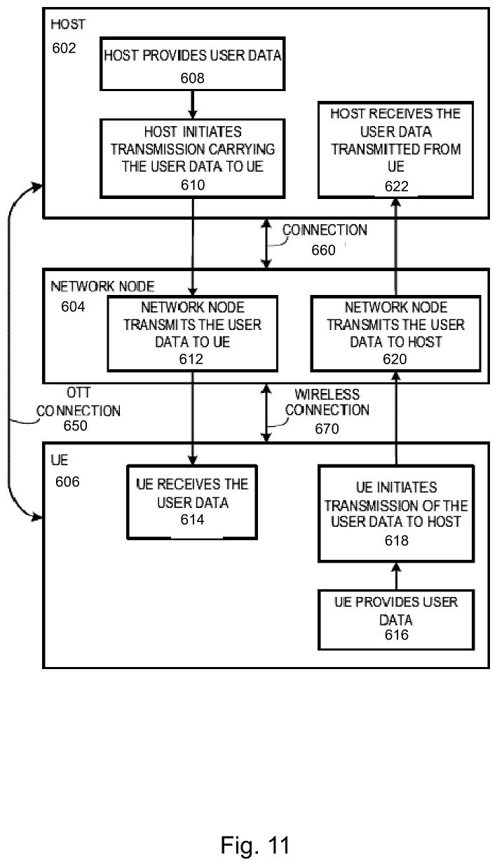

FIG. 11 shows a communication diagram of a host 602 communicating via a network node 604 with a UE 606 over a partially wireless connection in accordance with some embodiments. Example implementations, in accordance with various embodiments, of the UE (such as a UE 112a of FIG. 6 and/or UE 200 of FIG. 7), network node (such as network node 110a of FIG. 6 and/or network node 300 of FIG. 8), and host (such as host 116 of FIG. 6 and/or host 400 of FIG. 9) discussed in the preceding paragraphs will now be described with reference to FIG. 11.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 6) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve the delay to directly activate an SCell by RRC and power consumption of user equipment and thereby provide benefits such as reduced user waiting time and extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

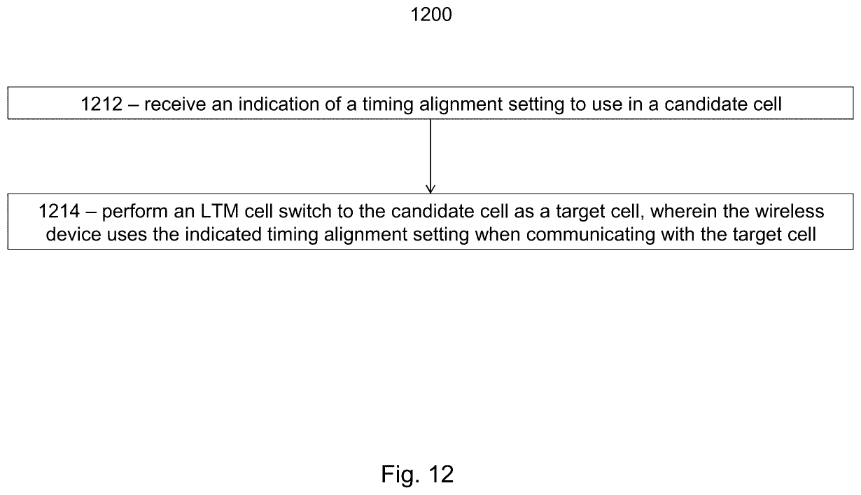

FIG. 12 is a flowchart illustrating an example method in a wireless device, according to certain embodiments. In particular embodiments, one or more steps of FIG. 12 may be performed by UE 200 described with respect to FIG. 7. The wireless device is operable to perform a LTM cell switch.

The method begins at step 1212, where the wireless device (e.g., UE 200) receives an indication of a timing alignment setting to use in a candidate cell. For example, the indication of the timing alignment setting may indicate how to handle time alignment in the candidate cell when an LTM switch procedure is initiated.

In particular embodiments, receiving the indication comprises receiving a MAC CE (such as a LTM cell switch command MAC CE). In particular embodiments, the indication of the timing alignment setting indicates a TA command.

In particular embodiments, the indication of the timing alignment setting is received from one of a source network node and a target network node.

In particular embodiments, the indication of the timing alignment setting is received before or during initiating a LTM cell switch procedure.

In particular embodiments, the indication of the timing alignment setting may include the indications in any of any of RRC examples 1-6 described above.

At step 1214, the wireless device performs an LTM cell switch to the candidate cell as a target cell. The wireless device may use the indicated timing alignment setting to determine how to handle time alignment in the target cell when communicating with the target cell. Examples of particular values and their associated actions are described in more detail above, and with respect to RRC examples 1-6.

In particular embodiments, the wireless device performs one of the following actions in response to the indication of the timing alignment setting: setting a TA value for the candidate cell to an explicit value included in the indication of the timing alignment setting; setting a TA value for the candidate cell to a TA value used for a serving cell; setting a TA value for the candidate cell to a TA value used for a serving cell, adjusted by an offset; setting a TA value for the candidate cell to a TA value used for a source cell; or setting a TA value for the candidate cell to a TA value used for a source cell, adjusted by an offset.

In particular embodiments, the wireless device performs one of the following actions in response to the indication of the timing alignment setting: setting a TA value for the candidate cell to a TA value used for a timing advance group (TAG) in a source configuration; or setting a TA value for the candidate cell to a TA value used for a TAG in a source configuration, adjusted by an offset.

In particular embodiments, the wireless device performs one or more of the following actions in response to the indication of the timing alignment setting: performing a random access procedure towards the candidate cell; and not setting a TA value for the candidate cell.

Modifications, additions, or omissions may be made to method 1200 of FIG. 12. Additionally, one or more steps in the method of FIG. 12 may be performed in parallel or in any suitable order.

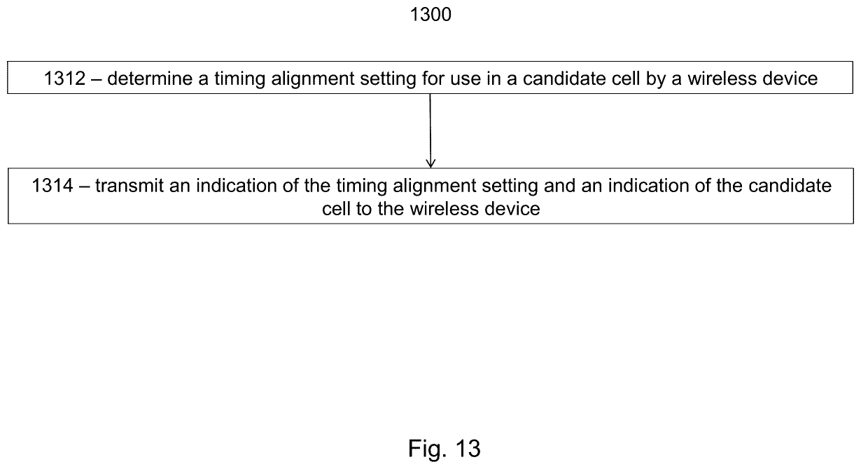

FIG. 13 is a flowchart illustrating an example method in a network node, according to certain embodiments. In particular embodiments, one or more steps of FIG. 13 may be performed by network node 300 described with respect to FIG. 8.

The method begins at step 1312, where the network node (e.g., network node 300) determines a timing alignment setting for use in a candidate cell by a wireless device. For example, the timing alignment setting may indicate how the wireless device will handle time alignment in the candidate cell when an LTM switch procedure is initiated.

In particular embodiments, the indication of the timing alignment setting indicates a TA command.

In particular embodiments, the network node comprises one of a source network node and a target network node.

At step 1314, the network node transmits an indication of the timing alignment setting and an indication of the candidate cell to the wireless device.

In particular embodiments, transmitting the indication comprises transmitting a MAC CE.

In particular embodiments, the indication of the timing alignment setting is transmitted before or during initiation of a LTM cell switch procedure.

In particular embodiments, the indication of the timing alignment setting is signaled as a field in a LTM cell switch command MAC CE.

Additional details are described above and with respect to RRC examples 1-6.

Modifications, additions, or omissions may be made to method 1300 of FIG. 13. Additionally, one or more steps in the method of FIG. 13 may be performed in parallel or in any suitable order.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

Some example embodiments follow.

### Group A Embodiments

1. A method performed by a wireless device for LTM cell switch, the method comprising:
   receiving an indication of a timing alignment setting to use in a candidate cell; and
   performing an LTM cell switch to the target cell, wherein the wireless device uses the indicated timing alignment setting when communicating with the target cell.
2. The method of embodiment 1, wherein receiving the indication comprises receiving a MAC CE.
3. The method of any one of the previous embodiments, wherein the indication of the timing alignment setting indicates a TA command.
4. The method of any one of embodiments 1-2, wherein the indication of the timing alignment setting does not indicate a TA command.
5. The method of any one of the previous embodiments, wherein the wireless device performs one of the following actions in response to the indication of the timing alignment setting:
   setting a TA value for the indicated candidate cell to an explicit value included in the indication of the timing alignment setting;
   setting a TA value for the indicated candidate cell to a TA value used for a serving cell;
   setting a TA value for the indicated candidate cell to a TA value used for a serving cell, adjusted by an offset;
   setting a TA value for the indicated candidate cell to a TA value used for a source cell;
   setting a TA value for the indicated candidate cell to a TA value used for a source cell, adjusted by an offset;
   setting a TA value for the indicated candidate cell to a TA value used for a Timing Advance Group, TAG, in the source configuration;
   setting a TA value for the indicated candidate cell to a TA value used for a Timing Advance Group, TAG, in a source configuration, adjusted by an offset;
   performing a random access procedure towards the indicated candidate cell; and
   not setting a TA value for the indicated candidate cell.
6. The method of any one of the previous embodiments, wherein the indication of the timing alignment setting is received from one of a source network node and a target network node.
7. The method of any one of the previous embodiments, wherein the indication of the timing alignment setting is received before or during initiating a LTM cell switch procedure.
8. The method of any one of the previous embodiments, wherein the indicated candidate cell is an indication of an LTM candidate cell configuration, such a candidate configuration index, an LTM configuration index or an LTM candidate cell index.
9. The method of any one of the previous embodiments, wherein the indicated candidate cell is a group of cells, such as a CellGroupConfig, a Master Cell Group (MCG) or a Secondary Cell Group (SCG).
10. The method of any one of the previous embodiments, wherein the indicated candidate cell is either an SpCell or an SCell, or a serving or source cell is either an SpCell or an SCell, or the indicated candidate and serving or source cells are different cells, e.g., use different physical cell identities or use or use different cell configurations, or the indicated candidate and serving or source cells are the same cell, e.g., use same physical cell identity or use same cell configuration.
11. The method of any one of the previous embodiments, wherein the indication of the timing alignment setting is signaled as a field in a MAC CE.
12. The method of embodiment 11, wherein the MAC CE including the indication of the timing alignment setting is a different MAC CE that the one used for initiating an LTM cell switch procedure.
13. The method of embodiment 11, wherein the MAC CE including the indication of the timing alignment setting is received separately from the MAC CE than the one used for initiating an LTM cell switch procedure.
14. The method of embodiment 11, wherein the MAC CE including the indication of the timing alignment setting is multiplexed in the same MAC PDU with the MAC CE as the one used for initiating an LTM cell switch procedure.
15. The method of embodiment 11, wherein an indication of no TA command is indicated by a MAC CE with a LCID that indicates that the TA command is not included.
16. The method of embodiment 11, wherein a setting of a TA value for the indicated candidate cell to the TA value used for the serving cell is signaled as a field in a MAC CE.
17. The method of embodiment 11, wherein a setting of a TA value for the indicated candidate cell to the TA value used for the serving cell adjusted by an offset received as a field in a MAC CE.
18. The method of embodiment 17, wherein the offset is received in the MAC CE.
19. The method of embodiment 17, wherein the offset is calculated by the wireless device.
20. The method of embodiment 17, wherein the offset is calculated based on a propagation delay difference between the serving and target cells.
21. The method of embodiment 11, where a random access procedure is triggered by a field in a MAC CE.
22. The method of embodiment 1, wherein a special value of an explicit value indicates that the wireless device shall set the TA value for a target cell to a TA value used for a serving cell.
23. The method of embodiment 1, wherein a special value of an explicit value indicates that the wireless device shall set the TA value for a target cell to a TA value used for a serving cell, adjusted by an offset.
24. The method of embodiment 23, wherein the offset is calculated by the wireless device.
25. The method of embodiment 23, wherein the offset is calculated based on a propagation delay difference between the serving and target cells.
26. The method of embodiment 2, wherein the MAC CE comprises any one of the MAC CEs described with respect to the example MAC CE implementations 1-4 described above.
27. The method of embodiment 1, wherein the wireless device determines that it should set a TA value for the indicated candidate cell to a TA value used for a serving cell or a source cell based on the indication of a candidate cell.
28. The method of embodiment 27, wherein the serving cell or source cell is an SpCell.
29. The method of embodiment 27, wherein the serving cell or source cell is an SCell.
30. The method of embodiment 1, wherein the indication of a candidate cell is an indication of an LTM candidate cell configuration, such as a candidate configuration index, an LTM configuration index or an LTM candidate cell index.
31. The method of embodiment 1, wherein the wireless device determines that it should set a TA value for the indicated candidate cell to a TA value used for a serving or a source cell adjusted by an offset based on the indication of a candidate cell.
32. The method of embodiment 31, wherein the serving cell or source cell is an SpCell.
33. The method of embodiment 31, wherein the serving cell or source cell is an SCell.
34. The method of embodiment 1, wherein the indication of a candidate cell is an indication of an LTM candidate cell configuration, such as a candidate configuration index, an LTM configuration index or an LTM candidate cell index.
35. The method of embodiment 31, wherein the offset is provided as part of an LTM candidate cell configuration.
36. The method of embodiment 31, wherein the offset is calculated by the UE.
37. The method of embodiment 31, wherein the offset is calculated based on a propagation delay difference between the serving and target cells.
38. The method of embodiment 32, wherein a random access procedure is triggered based on the candidate cell index.
39. A method performed by a wireless device, the method comprising:
   any of the wireless device steps, features, or functions described above, either alone or in combination with other steps, features, or functions described above.
40. The method of the previous embodiment, further comprising one or more additional wireless device steps, features or functions described above.
41. The method of any of the previous embodiments, further comprising:
   providing user data; and
   forwarding the user data to a host computer via the transmission to the base station.

### Group B Embodiments

42. A method performed by a base station for LTM cell switch, the method comprising:
   determining a timing alignment setting for use in a candidate cell by a wireless device; and
   transmitting an indication of the timing alignment setting and an indication of the candidate cell to the wireless device.
43. The method of embodiment 42, wherein transmitting the indication comprises transmitting a MAC CE.
44. The method of any one of embodiments 42-43, wherein the indication of the timing alignment setting indicates a TA command.
45. The method of any one of embodiments 42-43, wherein the indication of the timing alignment setting does not indicate a TA command.
46. The method of any one of embodiments 42-45, wherein the base station comprises one of a source network node and a target network node.
47. The method of any one of embodiments 42-46, wherein the indication of the timing alignment setting is transmitted before or during initiation of a LTM cell switch procedure.
48. The method of any one of embodiments 42-47, wherein the indicated candidate cell is an indication of an LTM candidate cell configuration, such a candidate configuration index, an LTM configuration index or an LTM candidate cell index.
49. The method of any one of embodiments 42-48, wherein the indicated candidate cell is a group of cells, such as a CellGroupConfig, a Master Cell Group (MCG) or a Secondary Cell Group (SCG).
50. The method of any one of embodiments 42-49, wherein the indicated candidate cell is either an SpCell or an SCell, or a serving or source cell is either an SpCell or an SCell, or the indicated candidate and serving or source cells are different cells, e.g., use different physical cell identities or use or use different cell configurations, or the indicated candidate and serving or source cells are the same cell, e.g., use same physical cell identity or use same cell configuration.
51. The method of any one of embodiments 42-50, wherein the indication of the timing alignment setting is signaled as a field in a MAC CE.
52. The method of embodiment 51, wherein the MAC CE including the indication of the timing alignment setting is a different MAC CE that the one used for initiating an LTM cell switch procedure.
53. The method of embodiment 51, wherein the MAC CE including the indication of the timing alignment setting is transmitted separately from the MAC CE than the one used for initiating an LTM cell switch procedure.
54. The method of embodiment 51, wherein the MAC CE including the indication of the timing alignment setting is multiplexed in the same MAC PDU with the MAC CE as the one used for initiating an LTM cell switch procedure.
55. The method of embodiment 51, wherein an indication of no TA command is indicated by a MAC CE with a LCID that indicates that the TA command is not included.
56. The method of embodiment 51, wherein a setting of a TA value for the indicated candidate cell to the TA value used for the serving cell is signaled as a field in a MAC CE.
57. The method of embodiment 51, wherein a setting of a TA value for the indicated candidate cell to the TA value used for the serving cell adjusted by an offset transmitted as a field in a MAC CE.
58. The method of embodiment 57, wherein the offset is received in the MAC CE.
59. The method of embodiment 57, wherein the offset is calculated by the wireless device.
60. The method of embodiment 57, wherein the offset is calculated based on a propagation delay difference between the serving and target cells.
61. The method of embodiment 51, where a random access procedure is triggered by a field in a MAC CE.
62. The method of embodiment 42, wherein a special value of an explicit value indicates that the wireless device shall set the TA value for a target cell to a TA value used for a serving cell.
63. The method of embodiment 42, wherein a special value of an explicit value indicates that the wireless device shall set the TA value for a target cell to a TA value used for a serving cell, adjusted by an offset.
64. The method of embodiment 63, wherein the offset is calculated by the wireless device.
65. The method of embodiment 63, wherein the offset is calculated based on a propagation delay difference between the serving and target cells.
66. The method of embodiment 43, wherein the MAC CE comprises any one of the MAC CEs described with respect to the example MAC CE implementations 1-4 described above.
67. The method of embodiment 42, wherein the indication of a candidate cell is an indication of an LTM candidate cell configuration, such as a candidate configuration index, an LTM configuration index or an LTM candidate cell index.
68. The method of embodiment 31, wherein the offset is provided as part of an LTM candidate cell configuration.
69. A method performed by a base station, the method comprising:
   any of the steps, features, or functions described above with respect to base station, either alone or in combination with other steps, features, or functions described above.
70. The method of the previous embodiment, further comprising one or more additional base station steps, features or functions described above.
71. The method of any of the previous embodiments, further comprising:
   obtaining user data; and
   forwarding the user data to a host computer or a wireless device.

### Group C Embodiments

72. A mobile terminal comprising:
   processing circuitry configured to perform any of the steps of any of the Group A embodiments; and
   power supply circuitry configured to supply power to the wireless device.
73. A base station comprising:
   processing circuitry configured to perform any of the steps of any of the Group B embodiments;
   power supply circuitry configured to supply power to the wireless device.
74. A user equipment (UE) comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
75. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
76. The communication system of the pervious embodiment further including the base station.
77. The communication system of the previous 2 embodiments, further including the UE, wherein the UE is configured to communicate with the base station.
78. The communication system of the previous 3 embodiments, wherein:
   the processing circuitry of the host computer is configured to execute a host application, thereby providing the user data; and
   the UE comprises processing circuitry configured to execute a client application associated with the host application.
79. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
80. The method of the previous embodiment, further comprising, at the base station, transmitting the user data.
81. The method of the previous 2 embodiments, wherein the user data is provided at the host computer by executing a host application, the method further comprising, at the UE, executing a client application associated with the host application.
82. A user equipment (UE) configured to communicate with a base station, the UE comprising a radio interface and processing circuitry configured to performs any of the previous 3 embodiments.
83. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
84. The communication system of the previous embodiment, wherein the cellular network further includes a base station configured to communicate with the UE.
85. The communication system of the previous 2 embodiments, wherein:
   the processing circuitry of the host computer is configured to execute a host application, thereby providing the user data; and
   the UE's processing circuitry is configured to execute a client application associated with the host application.
86. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
87. The method of the previous embodiment, further comprising at the UE, receiving the user data from the base station.
88. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
89. The communication system of the previous embodiment, further including the UE.
90. The communication system of the previous 2 embodiments, further including the base station, wherein the base station comprises a radio interface configured to communicate with the UE and a communication interface configured to forward to the host computer the user data carried by a transmission from the UE to the base station.
91. The communication system of the previous 3 embodiments, wherein:
   the processing circuitry of the host computer is configured to execute a host application; and
   the UE's processing circuitry is configured to execute a client application associated with the host application, thereby providing the user data.
92. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
93. A method implemented in a communication system including a host computer, a base station and a user equipment (UE), the method comprising:
   at the host computer, receiving user data transmitted to the base station from the UE, wherein the UE performs any of the steps of any of the Group A embodiments.
94. The method of the previous embodiment, further comprising, at the UE, providing the user data to the base station.
95. The method of the previous 2 embodiments, further comprising:
   at the UE, executing a client application, thereby providing the user data to be transmitted; and
   at the host computer, executing a host application associated with the client application.
96. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
97. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
98. The communication system of the previous embodiment further including the base station.
99. The communication system of the previous 2 embodiments, further including the UE, wherein the UE is configured to communicate with the base station.
100. The communication system of the previous 3 embodiments, wherein:
   the processing circuitry of the host computer is configured to execute a host application;
   the UE is configured to execute a client application associated with the host application, thereby providing the user data to be received by the host computer.
101. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
102. The method of the previous embodiment, further comprising at the base station, receiving the user data from the UE.
103. The method of the previous 2 embodiments, further comprising at the base station, initiating a transmission of the received user data to the host computer.

1. A method performed by a wireless device for layer one, L1, layer two, L2, mobility, LTM, cell switch, the method comprising:
receiving an indication of a timing alignment setting to use in a candidate cell; and
performing an LTM cell switch to the candidate cell as a target cell, wherein the wireless device uses the indicated timing alignment setting when communicating with the target cell.

2. The method of claim 1, wherein the indication of the timing alignment setting indicates how to handle time alignment in the candidate cell when an LTM switch procedure is initiated

3. The method of claim 1, wherein receiving the indication comprises receiving a medium access control, MAC, control element, CE.

4. The method of claim 1, wherein the indication of the timing alignment setting indicates a timing advance, TA, command.

5. The method of claim 1, wherein the wireless device performs one of the following actions in response to the indication of the timing alignment setting:
setting a timing advance, TA, value for the candidate cell to an explicit value included in the indication of the timing alignment setting;
setting a TA value for the candidate cell to a TA value used for a serving cell;
setting a TA value for the candidate cell to a TA value used for a serving cell, adjusted by an offset;
setting a TA value for the candidate cell to a TA value used for a source cell; or
setting a TA value for the candidate cell to a TA value used for a source cell, adjusted by an offset.

6. The method of claim 1, wherein the wireless device performs one of the following actions in response to the indication of the timing alignment setting:
setting a timing advance, TA, value for the candidate cell to a TA value used for a timing advance group, TAG, in a source configuration; or
setting a TA value for the candidate cell to a TA value used for a TAG in a source configuration, adjusted by an offset.

7. The method of claim 1, wherein the wireless device performs one or more of the following actions in response to the indication of the timing alignment setting:
performing a random access procedure towards the candidate cell; or
not setting a timing advance, TA, value for the candidate cell.

8. The method of claim 1, wherein the indication of the timing alignment setting is received from one of a source network node and a target network node.

9. The method of claim 1, wherein the indication of the timing alignment setting is received before or during initiating a LTM cell switch procedure.

10. The method of claim 1, wherein the indication of the timing alignment setting is signaled as a field in a LTM cell switch command medium access control, MAC, control element, CE.

11. A computer program product comprising a non-transitory computer readable medium storing computer readable program code, the computer readable program code operable, when executed by processing circuitry to perform any of the steps of claim 1.

12. A wireless device capable of layer one, L1, layer two, L2, mobility, LTM, cell switch, the wireless device comprising processing circuitry operable to:
receive an indication of a timing alignment setting to use in a candidate; and
perform an LTM cell switch to the candidate cell as a target cell, wherein the wireless device uses the indicated timing alignment setting when communicating with the target cell.

13. (canceled)

14. A method performed by a network node for layer one, L1, layer two, L2, mobility, LTM, cell switch, the method comprising:
determining a timing alignment setting for use in a candidate cell by a wireless device; and
transmitting an indication of the timing alignment setting and an indication of the candidate cell to the wireless device.

15. The method of claim 14, wherein the timing alignment setting indicates how to handle time alignment in the candidate cell when an LTM switch procedure is initiated

16. The method of claim 11, wherein transmitting the indication comprises transmitting a medium access control, MAC, control element, CE.

17. The method of claim 14, wherein the indication of the timing alignment setting indicates a timing advance, TA, command.

18. The method of claim 14, wherein the network node comprises one of a source network node and a target network node.

19. The method of claim 14, wherein the indication of the timing alignment setting is transmitted before or during initiation of a LTM cell switch procedure.

20. The method of claim 14, wherein the indication of the timing alignment setting is signaled as a field in a LTM cell switch command medium access control, MAC, control element, CE.

21. A computer program product comprising a non-transitory computer readable medium storing computer readable program code, the computer readable program code operable, when executed by processing circuitry to perform any of the steps of claim 14.

22. A network node capable of layer one, L1, layer two, L2, mobility, LTM, cell switch, the network node comprising processing circuitry operable to:
determine a timing alignment setting for use in a candidate cell by a wireless device; and
transmit an indication of the timing alignment setting and an indication of the candidate cell to the wireless device.

23. (canceled)
